(19) United States
(12) Patent Application Publication
(10) Pub. No.: US 2015/0167638 A1
(43) Pub. Date: Jun. 18, 2015

(54) TURBINE BLADE

(71) Applicant: Khalil Abu Al-Rubb, London (GB)

(72) Inventor: Khalil Abu Al-Rubb, London (GB)

(21) Appl. No.: 14/235,077

(22) PCT Filed: Jul. 26, 2012
(86) PCT No.: PCT/GB2012/051812

§ 371 Date: Feb. 27, 2015

(30) Foreign Application Priority Data
Jul. 26, 2011 (GB) 1112844.4

(51) Int. Cl. F03D 7/02; F03D 7/04; F03D 1/06

(52) U.S. Cl. CPC F03D 7/022; F03D 1/0675; F03D 7/042

(57) ABSTRACT

Embodiments of the invention relate to blades for turbines, such as wind turbines, comprising a structural frame with a sail mounted thereon. In certain embodiments, a portion of the frame contributes to the buoyancy of the blade. In further embodiments, the frame comprises strengthening cords.

In further embodiments, the frame comprises a reinforced tip. In further embodiments, the blade has a tip arranged to articulate relative to a body portion to alter the aerodynamic profile of the blade as the blade rotates to thereby assist up-strokes of the blade.

### CROSS-REFERENCES TO RELATED APPLICATIONS

This application is a national stage application under 35 U.S.C. 371 of, and claims a benefit of priority under 35 U.S.C. 365(a) and/or 35 U.S.C. 365(b) from, copending international application PCT/GB2012/051812, filed Jul. 26, 2012, now WO 2013/014463, published Jan. 31, 2013, the entire contents of which are hereby expressly incorporated herein by reference for all purposes. This application is related to, and claims a benefit of priority under one or more of 35 U.S.C. 119(a)-119(d) from copending foreign patent application GB 1112844.4, filed Jul. 26, 2011.

### FIELD OF EMBODIMENTS OF THE INVENTION

Embodiments of the invention relate to a blade for use with turbines and, in particular, wind turbines.

### BACKGROUND

As the dangers and environmental impact of traditional coal, oil, gas and nuclear power generation become better understood and appreciated, there is an increasing desire for alternative forms of generating power. In recent years, one of the more successful alternative methods of generating energy has been wind power. There are many different known arrangements for generating wind power, but most rely on the principle of providing a turbine having blades arranged to turn as a result of the force of the wind and to thereby generate energy.

The efficiency with which such wind-based electricity generation occurs depends upon the efficiency with which the kinetic energy of the wind can be converted into electrical energy which, in turn, depends upon the efficiency with which the blades can rotate about their axis of rotation.

Due to the manner in which wind turbines operate, the blades which rotate under the influence of the wind are often orientated to rotate vertically with respect to the ground. Therefore, for each up-stroke it is necessary to lift the blade against the force of gravity.

Furthermore, one of the known problems experienced during wind generation is that the blade arrangement (or the portion undergoing rotation due to the wind) is subjected to significantly varying forces as the speed of the wind changes. It is therefore known to simultaneously vary the moment of inertia of all of the blades of a blade arrangement by varying a weight arrangement about an axis of rotation. Such an arrangement is, for example, disclosed in WO 2004/011801.

However, such known arrangements vary the moment of inertia symmetrically and simultaneously about the axis of rotation. Furthermore, the means proposed for varying the moment of inertia rely on relatively expensive and friction-inducing arrangements.

Furthermore, blades used in known arrangements can be heavy causing wear on the bearings used to support the rotation of the blades. KR 2001 0067856 A discloses a rotor blade formed by a tube of a thin bullet-proof film filled with a helium gas reinforced by a bullet-proof textile laminated onto the tube.

### SUMMARY

According to a first aspect, the invention provides a blade for a turbine comprising a body portion having a tip wherein in the tip is moveable relative to the body portion to vary the aerodynamic properties of the blade.

By moving the tip of the blade relative to a body portion, embodiments of the invention can vary the aerodynamic profile of the blade. Where blades are mounted vertically with respect to the ground they rotate against the force of gravity for half of the rotation. In such circumstances, a small change in the aerodynamic profile of the blade can counteract the force of gravity, thereby significantly reducing the force required to lift the blade against gravity. This provides for a more efficient wind turbine incorporating such blades.

The blade may further comprise a hinge connecting the tip to the body portion. In such embodiments, the tip may move by articulating about the hinge.

The blade may further comprise an actuator for moving the tip relative to the body portion. In an embodiment, the actuator may comprise a motor and pulley system or worm gear or other mechanical, electrical or hydraulic actuator.

According to a further aspect, the invention provides a blade for a turbine, the blade comprising a structural frame and a sail mounted on the frame, the sail being mounted on the frame to provide wind resistance during use of the blade and to cause rotation of the blade, wherein the blade further comprises at least one buoyant element wherein the buoyant element forms a part of said structural frame.

By providing a buoyant element which forms part of the structural frame, embodiments of the invention provide a structure which acts to both reduce the effective weight of the blade and provide structural reinforcement. By reducing the effective weight of the blade, the load on the bearing supporting rotation of the blade is decreased and the force required to rotate the blade about its axle is reduced. Furthermore, the reduction of the load on the bearing results in less friction and stress acting on the bearings, resulting in a longer service life.

The frame may comprise a plurality of structural elements, wherein the buoyant element may be at least one of the structural elements.

The buoyant element may support the sail.

The buoyant element may provide a buoyancy to the blade.

The buoyant element may be filled with a fluid which is less dense than the fluid in which the blade is to be disposed.

The buoyant element may be filled with Helium.

According to a further aspect, the invention provides a blade for a turbine, the blade comprising a structural frame and a sail mounted on the frame, the sail being mounted on the frame to provide wind resistance during use of the blade to cause rotation of the blade, wherein the frame further comprises at least one collapsible element. In an embodiment, the collapsible element is a cord element.

By providing a blade having a structural frame and a sail mounted to the frame where the frame comprises at least one cord element, embodiments of the invention provide a lightweight structure which acts to support the sail of the blade. A cord is significantly lighter than the struts or beams used for known blades and therefore provides a significantly improved structure which is lighter and easier to construct and maintain.

Furthermore, the cord provides structural reinforcement whilst contributing to a frame which can be easily dismantled and transported, as it has significantly smaller dimensions than a frame which requires a single strut, particularly where a cord is used in the longer sections of the frame.

When the blade comprises an attack edge and a trailing edge, the cord element may correspond with either the attack edge or the trailing edge, or both simultaneously.

The frame may further comprise a first cord element and a second cord element wherein the first cord element corresponds to the attack edge and the second cord element corresponds to the trailing edge.

The cord element may be braided and may comprise a wire.

A further aspect of the invention extends to a blade arrangement comprising a plurality of blades as described arranged to rotate about an axis, the blade arrangement further comprising a sensor for determining a rotational position of a selected one of the blades relative to the axis and, in dependence on the position, moving the tip of the selected blade relative to the body portion of the selected blade.

The actuator may be connected to the sensor, in which case the actuator may move the tip relative to the body portion to alter the aerodynamic profile of the selected blade to assist the rotational motion of the blade.

The actuator may move the tip to a first position while the blade undergoes a downward motion and move the tip to a second position while the blade undergoes an upward motion.

The aerodynamic profile of the blade with the tip in the first position may assist downward rotation of the blade about the axis.

The aerodynamic profile of the blade with the tip in the second position may assist upward movement of the blade about the axis.

According to a further aspect, the invention provides a method of operating a blade for a turbine having a body portion and a tip, the method comprising moving the tip relative to the body portion to vary the aerodynamic properties of the blade.

A hinge may connect the tip to the body portion.

The method may further comprise providing an actuator for moving the tip relative to the body portion.

The actuator may comprise a motor and pulley system. The actuator may comprise any mechanical, hydraulic or electrical system acting in the prescribed manner. In one embodiment, the actuator is a worm gear.

According to a further aspect, the invention provides a method of constructing a blade for a turbine comprising providing a structural frame and mounting a sail to the frame, the sail being mounted on the frame to provide wind resistance during use of the blade to cause rotation of the blade, wherein the method further comprises providing at least one buoyant element as a part of said structural frame.

The frame may comprise a plurality of structural elements, wherein said buoyant element may be at least one of said structural elements.

The buoyant element may support the sail and may provide a buoyancy to said blade.

The buoyant element may be filled with a fluid which is less dense than the fluid in which the blade is to be disposed.

The buoyant element may be filled with Helium.

According to a further aspect, the invention provides a method of manufacturing a blade for a turbine comprising providing a structural frame and mounting a sail to the frame, the sail being mounted on the frame to provide wind resistance during use of the blade to cause rotation of the blade, wherein the method further comprises providing at least one collapsible element as part of the structural frame. In an embodiment, the collapsible element is a cord element.

The blade may comprise an attack edge and a trailing edge and the cord element may correspond with either of the attack edge or the trailing edge.

The method may further comprise providing a first cord element and a second cord element as part of the frame, wherein the first cord element corresponds to the attack edge and the second cord element corresponds to the trailing edge.

The cord element may be braided and may comprise a wire.

According to a further aspect, the invention provides a method of controlling a blade arrangement comprising a plurality of blades as described arranged to rotate about an axis, the method further comprising providing a sensor for determining a rotational position of a selected one of the blades relative to the axis, the method further comprising moving the tip of the selected blade relative to the body portion of the selected blade in dependence on the position of the selected blade about the axis.

The actuator may be connected to the sensor and the method may comprise using the actuator to move the tip relative to the body portion to alter the aerodynamic profile of the selected blade and thereby assist the rotational motion of the blade.

The method may further comprise using the actuator to move the tip to a first position while the blade undergoes a downward motion and move the tip to a second position while the blade undergoes an upward motion.

The aerodynamic profile of the blade with the tip in the first position may assist downward rotation of the blade about the axis.

The aerodynamic profile of the blade with the tip in the second position may assist upward movement of the blade about the axis.

### BRIEF DESCRIPTION OF THE DRAWINGS

Example embodiments of the invention are hereinafter described with reference to the accompanying diagrams which are not to scale and where:

FIG. 1 is a schematic diagram of a blade according to an embodiment of the invention;

FIG. 2 is a schematic arrangement of a blade according to a further embodiment of the invention;

FIG. 3 is a schematic illustration of a blade according to a further embodiment of the invention;

FIG. 4 is a schematic illustration of a blade according to a further embodiment of the invention in a first configuration;

FIG. 5 is a schematic illustration of the blade of FIG. 4 in a further configuration;

FIG. 6 is a schematic illustration of the blade of FIG. 4 in a further configuration; and

FIG. 7 is a schematic illustration of a blade arrangement according to a further embodiment of the invention.

### DESCRIPTION OF EXAMPLE EMBODIMENTS

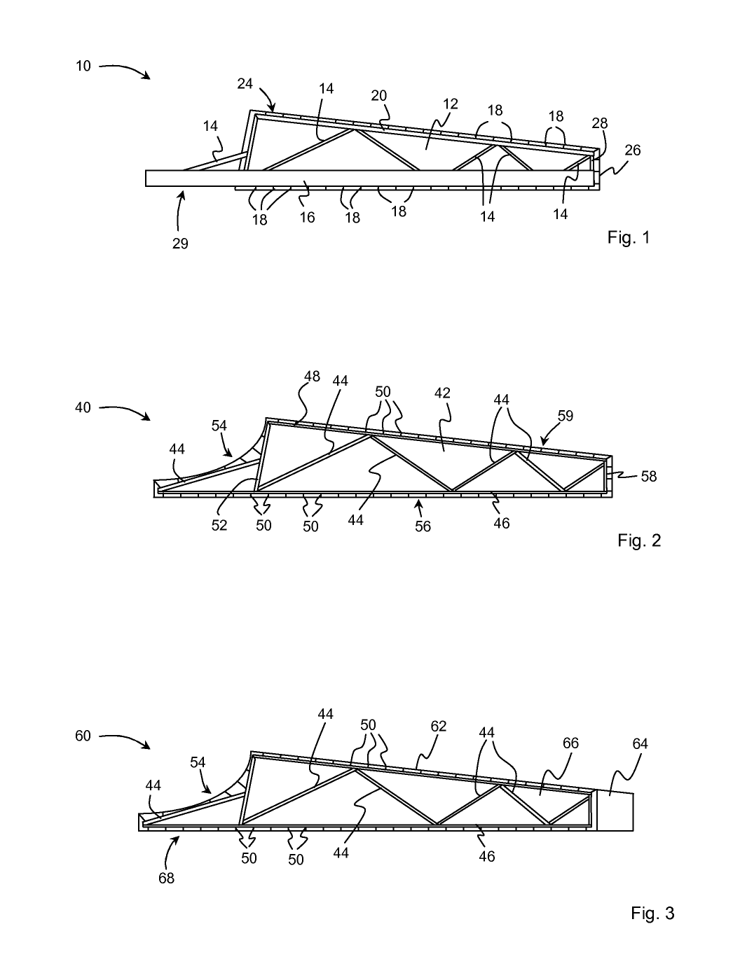

FIG. 1 illustrates a blade 10 according to an embodiment of the invention. The blade 10 comprises a frame 24 made out of struts 16 and 20 connected by crossbeams 14. The strut 16 lies along an edge of the blade 20 corresponding to the leading edge (in other words the edge which first engages with the fluid through which the blade passes as it rotates). Strut 20 corresponds to the trailing edge of the blade 10 (in other words the edge trailing the motion of the blade 10 as it rotates). Although a particular embodiment has been illustrated and described below, it is to be realised that the invention is not limited in this respect. In particular, embodiments of the invention may be implemented with frames which do not include struts or standard wind blade construction may also be used.

The blade 10 further comprises a sail 12 attached to the frame 24 by the means of a plurality of lines 18. In the embodiment illustrated in FIG. 1, the sail 12 is connected to the frame 24 by the lines 18 engaged between the edges of the sail 12 and the strut 16 of the leading edge and the strut 20 of the trailing edge, as well as a number of lines 18 attached between the tip edge 26 of the sail and a tip strut 28 of the frame 24. In an alternative embodiment, the sail 12 is connected to the frame 24 by hooks or other mechanical or chemical fitting means.

In each of the embodiments illustrated and described, where a sail is connected to a frame, the sail is illustrated as being connected to only one side of the frame (the back, with reference to the drawings). However, it is to be realised that embodiments of the invention may be provided with a sail covering both sides of the frame, in which case the frame would not be ordinarily visible. Further embodiments have two sails connected to obverse sides of the frame.

In the embodiment illustrated in FIG. 1, the strut 16 is hollow and has been filled with helium. The blade 10 is designed to be deployed in air and to rotate through action of the wind on the sail 12. Strut 16 corresponds to the leading edge of the blade and, in the embodiment illustrated, corresponds to the longest structural element of frame 24. According to this embodiment of the invention, only a single structural element of the frame 24 is filled with helium. In this instance, by providing the longest structural element filled with helium, the greatest buoyancy is achieved for the least amount of engineering involved in ensuring that the particular structural element is gastight.

As stated, the blade is intended to be deployed in air and, since helium is less dense than air, the strut 16 will contribute to the buoyancy of the blade 10. In further embodiments fluids other that Helium may be used to fill the buoyant element. The functional and cost-effectiveness of the fluid used will depend on the fluid in which the blade is to be disposed. In a further example, the blade is intended to be disposed in water, in which case the buoyant element is filled with air, which is cheaper than Helium but which, nonetheless, contributes to the buoyancy of the blade in that environment.

In the embodiment illustrated in FIG. 1, only a single structural element of the frame 24, strut 16, is provided filled with helium which therefore forms a buoyant element. In a further embodiment, two or more structural elements of the frame 24 may be filled with helium or other fluid. For example, with reference to Figure, both struts 16 and 20 may be filled with Helium. Although this will provide greater buoyancy, it does require that each structural element to be filled with helium be engineered to be gastight.

In a further embodiment, the entire frame, or a substantial part of the frame, is provided as a continuous, gas-filled element.

By providing a structural element which adds stiffness (structural rigidity) and buoyancy to the blade, the support function as well as a buoyancy function are subsumed into the same element. This is substantially more cost-effective and efficient than known blades.

It is to be realised however that the provision of buoyancy is not essential, provided that the structural element is provided with an enclosed space under pressure. The pressurisation provides added stiffness which adds to the structural integrity of the element while not contributing significantly to the weight. This can apply to any of the structural elements illustrated in FIG. 1.

The structural elements may be provided from carbon fibre, fibre glass, aluminium or any other light weight, impermeable material.

In certain embodiments, the structural elements are provided so that they are segmented. This facilitates transport and on-site construction.

FIG. 2 illustrates a blade 40 according to a further embodiment of the invention. The blade 40 comprises a frame 54 to which a sail 42 is attached by lines 50. The frame 54 comprises a number of crossbars 44 attached to one another. Instead of cross bars, tensioned cables, wires or any structural element may be used. Alternatively, known fibre glass (or other material) wind blade construction may be used. At a bottom end of the blade, (measured with reference to the rotation of the blade, the side of the blade at which the numeral ‘54’ is placed in FIG. 2) a structural element 52 is provided connected one of the cross bars 44. Similarly, at a tip portion (also measured with respect to the rotation of the blade 40 during use) a structural element 58 is connected attached to a cross bar 44.

A leading edge of the blade 56 has a cord 46 running through its length and attached to the frame 54. Furthermore, at a trailing edge 59, the blade 40 comprises a cord 48 also attached to the frame 54.

In the embodiment of FIG. 2, the cords 46 and 48 each provide a collapsible structure. Furthermore, the cords 46 and 48 each provide a lightweight reinforcement for the frame 54, significantly reducing the weight of the frame 54 over similar frames using rigid structures at the leading and trailing edges. Furthermore, collapsible structures such as cords are easy to pack and transport compared to more lengthy structural elements. Therefore, embodiments of the invention are suited to transport to regions which are accessible only over narrow mountain roads, rough terrain, or areas where no roads at all are provided.

Although the embodiment of FIG. 2 includes two cords, cords 46 and 48, further embodiments of the invention comprise a single collapsible element, which may be a cord.

FIG. 3 illustrates a blade 60 according to a further embodiment of the invention. The embodiment illustrated in FIG. 3 is similar to the blade 40 illustrated in FIG. 2 and, where appropriate, similar reference numerals have been used to refer to similar elements. The frame 54 of blade 60 has a sail 66 mounted thereon by lines 50. The sail 66, unlike the sail 42 of blade 40 illustrated in FIG. 2, is not attached to a tip portion of the blade. Instead, the blade 60 comprises a cap 64 over the blade tip. The cap 64 provides additional reinforcing to the frame 54 and protects the tip of the blade 60 against the effect of the air passing the blade 60 which, it would appreciated, is at a greater speed at the tip of the blade than elsewhere along the length of the blade. Therefore the cap 64 serves to protect the portion of the blade 60 most vulnerable to wear during use. The cap 64 may be constructed from steel or fibreglass. Alternatively, the cap 64 may be a filled region of the blade 60.

Although the steel cap is illustrated in conjunction with cords 46 and 48, it is to be realised that such caps may be used in conjunction with any blades prone to wear and tear.

A further aspect of the invention is illustrated by comparison between the blade 60 of FIG. 3 and the blade 10 of FIG. 1. The blade 60 comprises a base portion 68 where the sail 66 is attached by lines 50 to the frame 54. In comparison, the blade 10 of FIG. 1 includes a base portion 29 where the corresponding sail 12 is not connected to the supporting frame. In addition, element 44 in this embodiment may be provided as a tensioned cord. This provides extra stability to the blade by tensioning an additional portion of the blade.

It will be appreciated that the base portions 29 and 68 of corresponding blades 10 and 60 provide relatively little contribution to the function of the corresponding blade. The majority of the action of the blade is performed in the upper portions. Therefore, it has been realised that savings in both weight and materials can be made by providing a blade such as blade 10 of FIG. 1 where a base portion of the frame does not support the sail, and the sail is substantially restricted to the functional portion of the blade 10. It is to be realised that a separate flexible sail is not essential. The blade may be provided as a unibody, or with a blade portion mounted on a structural frame, having a pressurised or tensioned portion or member and the advantages discussed herein still apply.

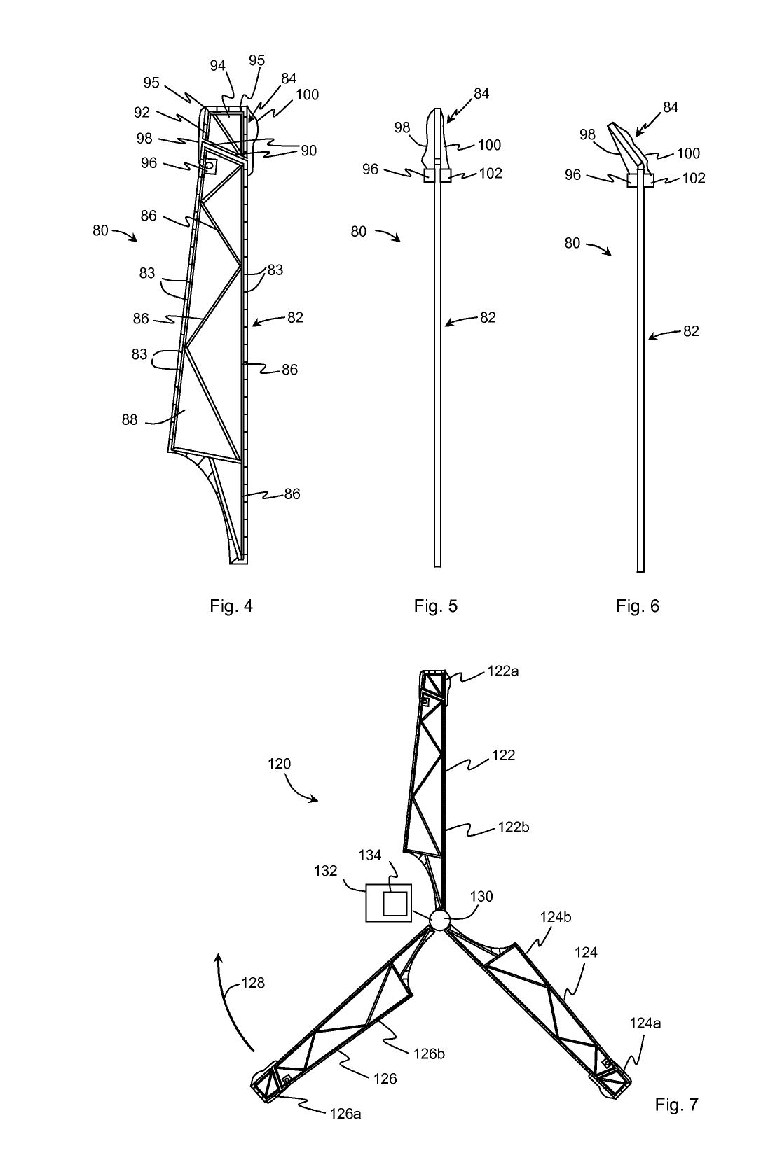

FIGS. 4, 5 and 6 illustrate a blade 80 according to a further embodiment of the invention. As illustrated in FIG. 4, blade 80 comprises a body portion 82 and a tip 84. The body portion 82 comprises a support frame made up of supporting struts 86 and a sail 88 connected to the struts 86 by lines 83.

Similarly, the tip 84 comprises a support frame made up of support struts 92 and a sail 94 connected to the support struts 92 by lines 94.

The tip 84 is connected to the body portion 82 by means of a hinge 90. In the embodiment shown the hinge 90 comprises two hinge members attached to the supporting struts 92 of the body portion 82 and the tip 84 (the means of attachment is not illustrated in FIG. 4).

The blade 80 further comprises a motorised pulley 96 connected by means of a cord 98 to the tip 84. The motorised pulley 96 is mounted on body portion 82. The arrangement of the motorised pulley 96 and the cord 98 is better illustrated in FIG. 5 which is a side view of the blade 80. As illustrated in FIG. 5, the blade 80 further comprises a second motorised pulley 102 mounted on an obverse side of body portion 82 to motorised pulley 96. Motorised pulley 102 is connected to tip 84 by cord 100.

The motorised pulleys 96 and 102 control the tension of corresponding cords 98 and 100. By tensioning the cord in the appropriate manner, the motorised pulleys 96 and 102 can cause the tip 84 to articulate relative to body portion 82 about hinge 90.

FIG. 6 illustrates the blade 80 when the motorised pulley 96 has been activated to tension cord 98 to cause tip portion 84 to articulate about hinge 90 relative to body portion 82. It will be realised that articulation of the tip 84 relative to body portion 82 in the other direction may be achieved through causing motorised pulley 102 to tension cord 100 while, at the same time, releasing the tension in cord 98 through appropriate activation of motorised pulley 96.

The pulleys 96 and 102 are controlled centrally by a controller, which is not illustrated in FIGS. 4, 5 and 6, but the operation of which is described below with reference to FIG. 7.

FIG. 7 illustrates a blade arrangement 120 comprising three blades 122, 124 and 126. Each of the blades 122, 124 and 126 is similar to the blade 80 illustrated in FIGS. 4, 5 and 6. Therefore blade 122 comprises body portion 122b and tip 122a; blade 124 comprises body portion 124b and tip 124a; and blade 126 comprises body portion 126b and tip 126a. The blades 122, 124 and 126 are mounted to an axle 130 and are arranged to rotate about the axle 130 in the direction of arrow 128 under the influence of a prevailing wind. It is to be realised that although the preferred embodiments refer to wind turbines, the principles herein described are equally applicable to blades for use in other turbines, such as flood turbines which operate in the sea.

Referring back to FIG. 7, the blade arrangement 120 further comprises a controller 132 having a sensor 134 connected to axis 130. The sensor 134 detects the angular position of the blades 122, 124 and 126 about the axis 130. The controller 132 controls the articulation of the tips 122a, 124a and 126a through the use of corresponding motorised pulleys and cords in the manner described above with reference to FIGS. 4, 5 and 6.

As the blade arrangement 120 rotates, the sensor 134 detects the angular position of the blades and the controller controls the articulation of the tips. As the tips articulate, the aerodynamic profile of the corresponding blade is altered. By controlling the articulation of the tips in dependence upon the rotational position of the blades, the controller 132 is able to use the strength of the prevailing wind to lift the blade during the up-stroke. The tip is returned to its original position during the down-stroke to ensure that the blade maintains its maximum efficiency.

In this manner, the blade arrangement 120 provides an arrangement whereby rotation of the blades 122, 124 and 126 about axis 130 is more efficient when compared to a similar arrangement, also mounted vertically with respect to the ground, which does not alter the aerodynamic profiles of the blades' independence upon their rotational position.

For each of the blades 122, 124 and 126, changing the position of the tip relative to the body portion will alter the aerodynamic profile of that blade. It is to be realised that to do so the tip need not be very large in comparison to the body portion. In a particular embodiment, the surface area of the tip is less than 5% of the surface are of the entire blade. In yet a further embodiment, the surface are of the tip is less than 1% of the surface area of the entire blade. In yet a further embodiment, the surface are of the tip is less than 1% of the surface area of the entire blade.

It will be appreciated that the particular design of the tip and the lift created by articulation of this relative to the blade will depend on a number of factors such as the speed at which the blade arrangement is designed to operate, and the viscosity of the fluid in which the blade arrangement is disposed. In any event, the required shape and size of the tip relative to the body portion can be determined through trial and error.

There follows a list of numbered features which relate to embodiments of the invention. Where a numbered feature refers to one or more other numbered features then those features should be considered in combination.

1. A blade for a turbine comprising a body portion having a tip wherein in the tip is moveable relative to the body portion to vary the aerodynamic properties of the blade.

2. The blade according to feature 1 further comprising a hinge connecting said tip to the body portion.

3. The blade according to feature 1 or feature 2 further comprising an actuator for moving the tip relative to the body portion.

4. The blade according to feature 3 wherein the actuator comprises a motor and pulley system.

5. A blade arrangement comprising a plurality of blades according to any of features 1 to 4 arranged to rotate about an axis, said blade arrangement further comprising a sensor for determining a rotational position of a selected one of said blades relative to the axis and, in dependence on said position, moving the tip of the selected blade relative to the body portion of the selected blade.

6. The blade arrangement according to feature 5, when dependent on feature 3, wherein the actuator is connected to the sensor, and wherein the actuator moves the tip relative to the body portion to alter the aerodynamic profile of the selected blade to assist the rotational motion of the blade.

7. The blade arrangement according to feature 6 wherein the actuator moves the tip to a first position while the blade undergoes a downward motion and moves the tip to a second position while the blade undergoes an upward motion.

8. The blade arrangement according to feature 7 wherein the aerodynamic profile of the blade with the tip in the first position assists downward rotation of the blade about the axis.

9. The blade arrangement according to feature 8 wherein the aerodynamic profile of the blade with the tip in the second position assists upward movement of the blade about the axis.

10. A blade for a turbine, the blade comprising a structural frame and a sail mounted on the frame, the sail being mounted on the frame to provide wind resistance during use of the blade and to cause rotation of the blade, wherein the blade further comprises at least one buoyant element wherein the buoyant element forms a part of said structural frame.

11. The blade according to feature 10 wherein said frame comprises a plurality of structural elements, and wherein said buoyant element is at least one of said structural elements.

12. The blade according to feature 10 or feature 11 wherein said buoyant element supports said sail.

13. The blade according to any preceding feature wherein said buoyant element provides a buoyancy to said blade.

14. The blade according to feature 13 wherein said buoyant element is filled with a fluid which is less dense than the fluid in which the blade is to be disposed.

15. The blade according to feature 14 wherein said buoyant element is filled with Helium.

16. A blade for a turbine, the blade comprising a structural frame and a sail mounted on the frame, the sail being mounted on the frame to provide wind resistance during use of the blade to cause rotation of the blade, wherein the frame further comprises at least one collapsible element.

17. The blade according to feature 16 wherein in the collapsible element is a cord.

18. The blade according to feature 16 or feature 17 comprising an attack edge and a trailing edge and wherein said cord element corresponds with either of the attack edge or the trailing edge.

19. The blade according to feature 18 wherein the frame further comprises a first cord element and a second cord element wherein the first cord element corresponds to the attack edge and the second cord element corresponds to the trailing edge.

20. The blade according to any of features 16 to 19 wherein said cord element is braided or filament winded.

21. The blade according to any of features 16 to 20 wherein said cord element comprises a wire.

22. A blade for a turbine comprising a body portion and a tip and a protective member covering the tip.

23. The blade according to feature 22 wherein the protective member is made of steel or composite.

24. The blade according to feature 22 or feature 23 wherein the protective member covers a portion of the blade and protects the covered portion from wear and tear.

25. The blade according to feature 22 wherein the blade further comprises a frame and a sail mounted to the frame wherein the protective member acts to protect a portion of the sail.

26. A blade for a turbine, the blade comprising a structural frame and a sail mounted on the frame, the blade having a functional portion which allows the blade to move under the influence of a moving fluid in which the blade is immersed, wherein the sail is only mounted to a portion of the frame corresponding to the functional portion of the blade.

27. The blade according to feature 26 wherein the blade further comprises a blade structure having a portion of said frame without the sail mounted thereto.

28. The blade according to any of features 9 to 24 or 26 further comprising a reinforcing cap.

29. A method of operating a blade for a turbine having a body portion and a tip, the method comprising moving the tip relative to the body portion to vary the aerodynamic properties of the blade.

30. The method according to feature 43 wherein a hinge connects said tip to the body portion.

31. The method according to feature 43 or feature 44 further comprising providing an actuator for moving the tip relative to the body portion.

32. The method according to feature 45 wherein the actuator comprises a motor and pulley system.

33. A method of controlling a blade arrangement comprising a plurality of blades according to any of features 1 to 3, 24 or 25 arranged to rotate about an axis, said method further comprising providing a sensor for determining a rotational position of a selected one of said blades relative to the axis, the method further comprising moving the tip of the selected blade relative to the body portion of the selected blade in dependence on the position of the selected blade about the axis.

34. The method according to feature 33, when dependent on feature 31, wherein the actuator is connected to the sensor, the method comprising using the actuator to move the tip relative to the body portion to alter the aerodynamic profile of the selected blade and thereby to assist the rotational motion of the blade.

35. The method according to feature 34 further comprising using the actuator to move the tip to a first position while the blade undergoes a downward motion and move the tip to a second position while the blade undergoes an upward motion.

36. The method according to feature 35 wherein the aerodynamic profile of the blade with the tip in the first position assists downward rotation of the blade about the axis.

37. The method according to feature 36 wherein the aerodynamic profile of the blade with the tip in the second position assists upward movement of the blade about the axis.

38. A method of constructing a blade for a turbine comprising providing a structural frame and a sail mounted on the frame, the sail being mounted on the frame to provide wind resistance during use of the blade to cause rotation of the blade, wherein the method further comprises providing at least one buoyant element as a part of said structural frame.

39. The method according to feature 38 wherein said frame comprises a plurality of structural elements, and wherein said buoyant element is at least one of said structural elements.

40. The method according to feature 38 or feature 39 wherein said buoyant element supports said sail.

41. The method according to any of features 38 to 40 wherein said buoyant element provides a buoyancy to said blade.

42. The method according to feature 41 wherein said buoyant element is filled with a fluid which is less dense than the fluid in which the blade is to be disposed.

43. The method according to feature 42 wherein said buoyant element is filled with Helium.

44. A method of manufacturing a blade for a turbine comprising providing a structural frame and a sail mounted on the frame, the sail being mounted on the frame to provide wind resistance during use of the blade to cause rotation of the blade, wherein the method further comprises providing at least one collapsible member such as a cord element as part of the structural frame.

45. The method according to feature 44 wherein the blade comprises an attack edge and a trailing edge and wherein said cord element corresponds with either of the attack edge or the trailing edge.

46. The method according to feature 45 comprising providing a first cord element and a second cord element as part of the frame, wherein the first cord element corresponds to the attack edge and the second cord element corresponds to the trailing edge.

47. The method according to any of features 44 to 45 wherein said cord element is braided.

48. The method according to any of features 44 to 47 wherein said cord element comprises a wire.

49. A method of manufacturing a blade for a turbine comprising providing a body portion and a tip and a protective member covering the tip.

50. The method according to feature 49 wherein the tip is made of steel.

51. The method according to feature 49 or feature 50 wherein the tip covers a portion of the blade and protects the covered portion from wear and tear.

52. A method of constructing a blade having a functional portion and a non-functional portion, the functional portion contributing to the motion of the blade due to motion of a fluid in which the blade is immersed, the method comprising attaching a sail only to the functional portion.

53. The method according to feature 52 further comprising providing a frame having a base structure, said base structure being provided without a sail.

1. A blade for a turbine comprising a body portion having a tip wherein in the tip is moveable relative to the body portion to vary the aerodynamic properties of the blade.

2. The blade according to claim 1 further comprising a hinge connecting said tip to the body portion.

3. The blade according to claim 1 further comprising an actuator for moving the tip relative to the body portion.

4. The blade according to claim 3 wherein the actuator comprises a motor and pulley system.

5. A blade arrangement comprising a plurality of blades according to claim 1 arranged to rotate about an axis, said blade arrangement further comprising a sensor for determining a rotational position of a selected one of said blades relative to the axis and, in dependence on said position, moving the tip of the selected blade relative to the body portion of the selected blade.

6. The blade arrangement according to claim 5, wherein the blade arrangement further comprises a sensor for determining a rotational position of a selected one of said blades relative to the axis and, in dependence on said position, moving the tip of the selected blade relative to the body portion of the selected blade, and wherein the actuator is connected to the sensor, and wherein the actuator moves the tip relative to the body portion to alter the aerodynamic profile of the selected blade to assist the rotational motion of the blade.

7. The blade arrangement according to claim 6 wherein the actuator moves the tip to a first position while the blade undergoes a downward motion and moves the tip to a second position while the blade undergoes an upward motion.

8. The blade arrangement according to claim 7 wherein the aerodynamic profile of the blade with the tip in the first position assists downward rotation of the blade about the axis.

9. The blade arrangement according to claim 8 wherein the aerodynamic profile of the blade with the tip in the second position assists upward movement of the blade about the axis.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. The blade according to claim 9 further comprising a reinforcing cap.

29. A method of operating a blade for a turbine having a body portion and a tip, the method comprising moving the tip relative to the body portion to vary the aerodynamic properties of the blade.

30. The method according to claim 29 wherein a hinge connects said tip to the body portion.

31. The method according to claim 29 further comprising providing an actuator for moving the tip relative to the body portion.

32. The method according to claim 31 wherein the actuator comprises a motor and pulley system.

33. A method of controlling a blade arrangement comprising a plurality of blades according to claim 1 arranged to rotate about an axis, said method further comprising providing a sensor for determining a rotational position of a selected one of said blades relative to the axis, the method further comprising moving the tip of the selected blade relative to the body portion of the selected blade in dependence on the position of the selected blade about the axis.

34. The method according to claim 33 further comprising providing an actuator for moving the tip relative to the body portion, and wherein the actuator is connected to the sensor, the method comprising using the actuator to move the tip relative to the body portion to alter the aerodynamic profile of the selected blade and thereby to assist the rotational motion of the blade.

35. The method according to claim 34 further comprising using the actuator to move the tip to a first position while the blade undergoes a downward motion and move the tip to a second position while the blade undergoes an upward motion.

36. The method according to claim 35 wherein the aerodynamic profile of the blade with the tip in the first position assists downward rotation of the blade about the axis.

37. The method according to claim 36 wherein the aerodynamic profile of the blade with the tip in the second position assists upward movement of the blade about the axis.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)
